(19) United States
(12) Patent Application Publication
(10) Pub. No.: US 2016/0288602 A1
(43) Pub. Date: Oct. 6, 2016

(54) CONVERTIBLE CARGO CARRIER AND CART SYSTEM ACCESSORIES

(71) Applicant: Alan S. Poudrier, Niceville, FL (US)

(72) Inventor: Alan S. Poudrier, Niceville, FL (US)

(21) Appl. No.: 14/679,067

(22) Filed: Apr. 6, 2015

(51) Int. Cl. B60D 1/42; F16M 13/02; B62K 27/00

(52) U.S. Cl. CPC B60D 1/42; B62K 27/003; F16M 13/02

(57) ABSTRACT

Convertible cargo carrier and cart system accessories provide a means to convert a typical receiver hitch cargo carrier into a wheeled cart that may be transported manually or pulled behind a bicycle. Handles, either manual or attachable to a bicycle, is received within the hitch mountable receiver tube. An offset wheel accessory provides a means to convert the platform of the cargo carrier to a wheeled platform for transporting cargo manually or pulling cargo with a bicycle. A bicycle receiver accessory, attachable to a bicycle, provides a means to receive and couple the cargo carrier to the bicycle when the cargo carrier is utilized in the capacity of a trailer. Convertible cargo carrier and cart system vertical members can hold articles such as barbeque grills for transport via a receiver hitch cargo carrier, a bicycle trailer, or a handcart.

This application claims the benefit of U.S. provisional patent application No. 61/978,787, filed on Apr. 11, 2014, and also claims the benefit of U.S. application Ser. No. 14/631,696, filed on Feb. 25, 2015, all of which are incorporated herein by reference in their entirety.

### BACKGROUND OF THE INVENTION

1. Field of the Invention

The present invention relates to a device that functions as a bicycle carrier that is removably attached to a tailgate hitch receiver and that can hold various accessories and that can convert to a wheeled cart, pulled either by hand or by a bicycle.

2. Background of the Prior Art

Bicycle owners who transport their bicycles via automobile utilize a bicycle carrier that is attached to the automobile by way of a hitch receiver or other means.

Bicycle carriers are typically a unitary function article in that upon arrival at a destination, for example a recreational park, the bicycle carrier offers no additional utility to their use. Current bicycle carriers do no offer help in transporting cargo or other articles other than bicycles.

Accordingly, there is a need in the art for a device that can increase the overall utility of a typical bicycle carrier so that the carrier has substantial utility to a user beyond the primary function of transporting the bicycle. Such a device must offer assistance in cargo transport when the bicycle and the bicycle carrier is detached from the vehicle and connected together in the form of a bicycle and bicycle trailer. Such a device must be of relatively simple construction and be easy to use.

### SUMMARY OF THE INVENTION

The convertible cargo carrier and cart system accessories of the present invention addresses the aforementioned needs in the art by providing accessories to a comprehensive cargo carrier system that when the cargo carrier is removed from the distal end of a typical tailgate hitch mounted carrier the accessories transform the cargo carrier used to transport a bicycle into a land cart or bicycle trailer allowing the convertible cargo carrier and cart system to transport cargo and articles when detached from the vehicle. A desired handle, either a handheld handle, or a handle that attaches to a velocipede or other vehicle ATV, motorcycle, etc., is attachable to the convertible cargo carrier and cart in order to tow the cargo carrier that has been converted to a cart. The convertible cargo carrier and cart system accessories are of relatively simple design and construction, being produced using standard manufacturing techniques, so as to make the device relatively inexpensive to produce so as to make the invention economically attractive to potential consumers of this type of device.

### BRIEF DESCRIPTION OF THE DRAWINGS

FIG. 1 is a perspective view of the convertible cargo carrier and cart system utilized to transport a bicycle.

FIG. 2 is a perspective view of the convertible cargo carrier and cart system utilized to transport a barbeque grill.

FIG. 3 is a perspective view of a bicycle utilized to transport the convertible cargo carrier and cart system a grill attached to the cart.

FIG. 4 is a detailed view of the bicycle receiver accessory.

FIG. 5 is an exploded view of the coupling of the bicycle receiver accessory

FIG. 6 is an assembled view of the coupling of the bicycle receiver accessory.

FIG. 7 is a detailed view of the barbeque grill bracket accessory

FIG. 8 is a detailed view of the underside of the barbeque grill bracket accessory

FIG. 9 is an environmental view of the straight handle assembly

FIG. 10 is an environmental view of the offset handle assembly

FIG. 11 is an expanded view of the offset wheel and spindle accessory

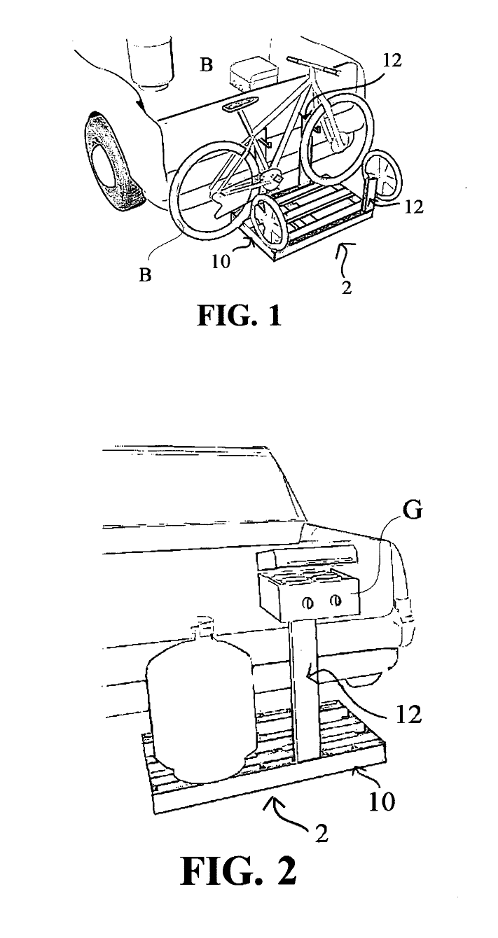

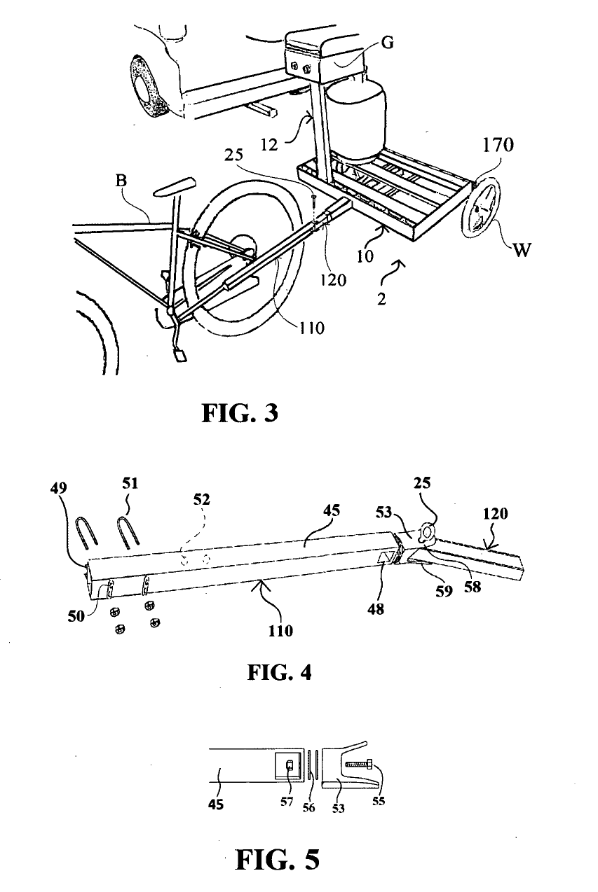

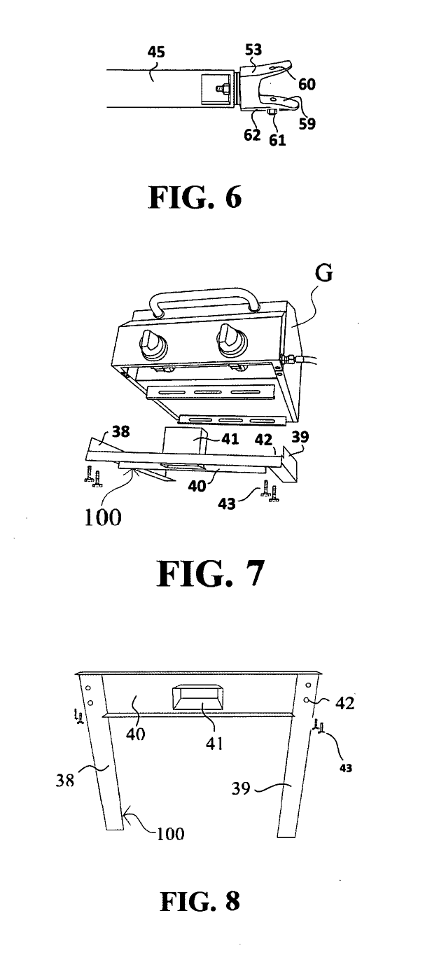

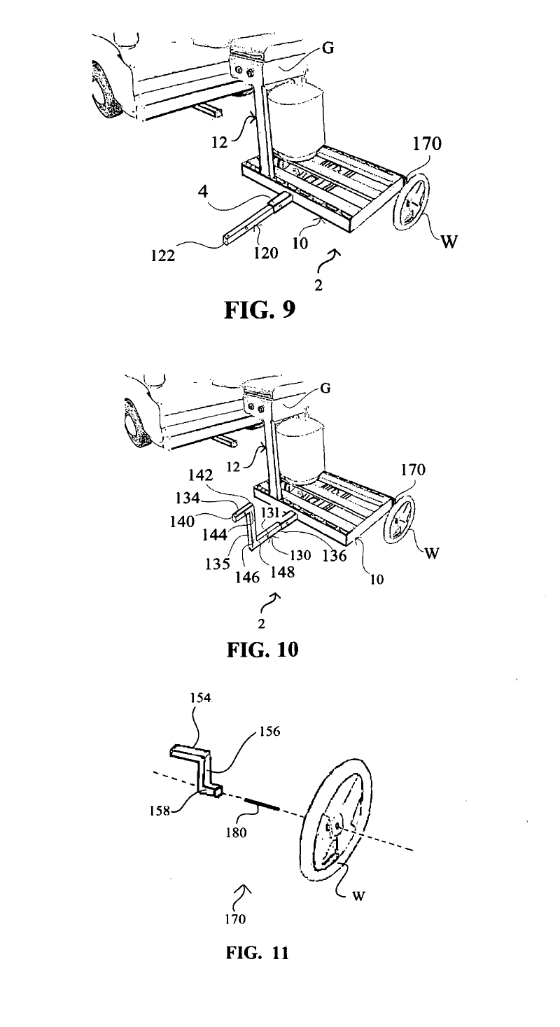

Similar reference numerals refer to similar parts throughout the several views of the drawings.

### DESCRIPTION OF THE PREFERRED EMBODIMENT

Referring now to the drawings, it is seen that a convertible cargo carrier and cart system, generally denoted by reference numeral 2 can be used to transport a variety of articles when appropriate article support devices 12 are attached to the cargo carrier 10.

A bicycle B and/or barbeque grill G may be secured to the convertible cargo carrier and cart system's 2 article support devices 12 and transported to a destination.

A barbeque grill bracket accessory 100 can be attached to a barbeque grill G. An opening on the underside barbeque grill bracket accessory 100 provides a method to attach the barbeque grill G to an article support device 12.

As seen in FIG. 8, the barbeque grill bracket accessory 100 has a channel component 40 having a front side, a top side, a bottom side, a rear side, and two ends. The rear side of channel component 40 is notched at both ends to allow the angle components 38 and 39 to be attached to the bottom of channel component 40 and also allow the inside angle of angle components 38 and 39 to be flush with the ends of channel component 40.

Angle components 38 and 39, and channel component 40 can be connected by passing common hardware through 4 holes 42. Holes 42 may also facilitate securing a barbeque grill G providing that the grill has holes that align with holes 42 of the barbeque grill bracket accessory 100.

Rectangular tube component 41 is approximately 4″ in length and has a top end and a bottom end. The top end of the rectangular tube component 41 passes through channel component 40 and extends approximately 3″ above the top side of 40. The bottom end of 41 extends approximately 1″ below the top side of channel component 40. Channel component 40 and rectangular tube component 41 are welded, bonded, or molded together along the top and bottom surfaces of channel component 40. All 4 sides of the bottom end opening of the rectangular tube 41 are tapered outward creating a greater opening at the bottom end of the rectangular tube 41 as compared to the top end of rectangular tube 41.

As seen, the barbeque grill G is attached to the article support device 12 by aligning the bottom opening of the rectangular tube component 41 and sliding the opening over the end of the article support device 12.

A bicycle receiver accessory 110 consists of a rigid member 45 and a rotate-able member 53. The rigid member 45 and the rotate-able member 53 are connected with common hardware. A cutout on the left rear side of the rigid member 45 allows access to install and tighten the hardware.

A channel component 49 approximately 4″ in length and approximately ½″ wide is welded bonded or molded on the right side of the rigid member 45. It is intended to fit over a bicycle B frame in front of the rear axle. Two holes 52 that are provided to allow some horizontal adjustment to the position of rigid member 45 with respect to the bicycle B frame. Holes 52 are intended to fit over the bicycle B axle's lock nut.

Four holes 50 pass through the rigid member 45. Holes 50 are provided to allow U-bolts 51 to fit over the bicycle B frame and pass through the rigid member 45 to secure the bicycle receiver accessory 12 to the bicycle B.

The bicycle receiver accessory's 110 rigid member 45 is attached to the rotate-able member 53 by passing a bolt 55 through the front end of 53. Two washers 56 are placed over the bolt 55 and between the rigid member 45 and the front end of the rotate-able member 53. The bolt 55 is passed through the rear end of the rigid member 45 and the secured with a self-locking nut or other common hardware that will allow the hardware to be secure without over tightening to the point that bolt 53 will not rotate freely.

A hole 60 passes through the upper tab 58 and bottom tab 59 of the rotate-able member 53. A nut 61 is welded, bonded, or molded to the bottom tab 59 of the rotate-able member 53. Two pieces of flat-stock material 62 approximately ⅛″ wide, ½″ high and approximately the length of the rotate-able member 53 are attached to the underside of bottom tab 59 on each side of the nut 61. This flat-stock material is intended to strengthen the bottom tab 59.

A straight handle accessory 120 or an offset handle accessory 130 used with a convertible cargo carrier and cart system 2 may be inserted into the receiver tube 4 of the cargo carrier 10.

The straight handle accessory 120 is comprised of square tubing 122 having a first end 124 and a second end 126. The straight handle accessory 120 also having a plurality of flat bar filler pieces 128. Flat bar filler pieces 128 are welded, bonded, or molded to the square tubing 122 in a plurality of locations between the first end 124 and a second end 126. The flat bar filler pieces 128 fill the void between the outer walls of square tubing 122 and the inner walls of the receiver tube 4 of the cargo carrier 10 in order to provide a snug fit when the straight handle accessory 120 is inserted into the receiver tube 4 of the cargo carrier 10.

Approximately 8 inches of the first end 124 of the straight handle accessory 120 is void of flat bar filler pieces 128 in order to provide allow a comfortable hand grip of the straight handle accessory 120. The straight handle accessory 120 also having holes 129 passing through the square tubing 122 in order to allow a pin (not shown) to pass through the receiver tube 4 of the cargo carrier 10 and also through the holes 129 of the square tubing 122. A hole 27 passes from the top of the straight handle accessory 120 and through the bottom of the straight handle accessory 120 approximately 1 inch from the first end 124. Hole 27 allows the user to insert a pin or bolt 25 through the upper tab 58 of bicycle receiver accessory 110, through the square tubing 122 of the straight handle accessory 120, and through the bottom tab 59 of the rotate-able member 53 of the straight handle accessory 120 to secure the Bicycle B to the cargo carrier 10.

An offset handle accessory 130 used with a convertible cargo carrier and cart system 2 may also be inserted into the receiver tube 4 of the cargo carrier 10.

The offset handle accessory 130 is comprised of square tubing member 134, having a first end 140 and second end 142, square tubing member 135 having a first end 144 and second end 146, and square tubing member 136 having a first end 148 and a second end 150 (not shown). The second end 140 of the square tubing member 134 is welded, bonded, or molded to the first end 144 of the square tubing member 135 forming a right angle between square tubing member 134 and square tubing member 135. The second end 146 of the square tubing member 135 is welded, bonded, or molded to the first end 148 of the square tubing member 136 forming a right angle between square tubing member 135 and square tubing member 136.

The offset handle accessory 130 also having a plurality of flat bar filler pieces 138 (not shown). Flat bar filler pieces 138 are welded, bonded, or molded to square tubing member 136 in a plurality of locations on the. The flat bar filler pieces 138 fill the void between the outer walls of square tubing member 136 and the inner walls of the receiver tube 4 of the cargo carrier 10 in order to provide a snug fit when the offset handle accessory 130 is inserted into the receiver tube 4 of the cargo carrier 10.

The offset handle accessory 130 also having holes 131 passing through the square tubing 134 in order to allow a pin (not shown) to pass through the receiver tube 4 of the cargo carrier 10 and also through the holes 131 of the square tubing 134.

An offset wheel and spindle accessory 170 is comprised of square tubing member 154, square tubing member 156, and square tubing member 158. Square tubing member 154 is welded, bonded, or molded to square tubing member 156 forming a right angle between square tubing member 154 and square tubing member 156. The opposite end of square tubing member 156 is welded, bonded, or molded square tubing member 158 forming a right angle between square tubing member 156 and square tubing member 158.

A spindle 180 comprised of round stock material passes through square tubing member 160 and protrudes beyond the one end square tubing member 160 approximately ¼ inch. The spindle 180 protrudes beyond the opposite end of square tubing member 160 to extend beyond the width of a wheel and hub assembly W and provide sufficient length to secure the wheel and hub assembly W to the spindle 180 via common hardware (none shown).

I claim:

1. A bicycle receiver accessory having a rigid member and a rotate-able member such that the rigid member can be connected to a bicycle frame using common hardware such as U-bolts and extends longitudinally and horizontally reward toward beyond the bicycle's axel where it is attached to the rotatable member via common hardware;
wherein, the rotatable member has upper and lower flanges to receive a handle or hitch-end of a trailer that may be pulled by the bicycle
wherein, the rotate-able member has the ability to rotate clockwise or counter-clockwise while a handle or hitch-end of a trailer is connected to the rotate-able member of the bicycle receiver accessory.

2. A barbeque grill bracket accessory having a frame that can be attached to a barbeque grill with common hardware and can support said barbeque grill;
wherein, the frame has a receiving opening that allows the receiving opening of the barbeque grill bracket accessory to be inserted onto a pedestal or post to support the barbeque grill bracket accessory.

3. A straight handle accessory;
wherein, the straight handle accessory is comprised of a rigid member wherein, one end of the rigid member can be inserted into a receiver hitch cargo carrier's receiver tube forming a snug fit and wherein, the opposing end of the rigid member extends beyond the cargo carrier's receiver tube in order to provide an extension of the receiver tube wherein, the rigid member can be coupled with the bicycle receiver accessory described in claim 1 wherein, the cargo carrier can be utilized in the capacity of a bicycle trailer;
wherein, the rigid member extends beyond the cargo carrier's receiver tube in order to provide an extension of the receiver tube wherein, the rigid member can serve as an extension of the cargo carrier's receiver tube serving as a handle when manually utilizing the cargo carrier in the capacity of a handcart.

4. An offset handle accessory;
wherein, the offset handle accessory is comprised of three square tubing members wherein, a first rigid member can be inserted into a receiver hitch cargo carrier's receiver tube forming a snug fit and wherein, the opposing end of the rigid member extend beyond the receiver tube wherein, the first rigid member is welded bonded or molded to a second rigid member that turns vertically upward at a right angle wherein, the second rigid member is welded bonded or molded turns to a third rigid member that turns horizontally in line with the first rigid member wherein, the third rigid member can be coupled with the bicycle receiver accessory described in claim 1 wherein, the cargo carrier can be utilized in the capacity of a bicycle trailer;
wherein, the offset handle accessory can serve as an extension of the cargo carrier's receiver tube and serve as a handle when manually utilizing the cargo carrier in the capacity of a handcart.

5. An offset wheel and spindle accessory having a first rigid member that can be inserted into a receiver hitch cargo carrier wherein, the rigid member is welded bonded or molded to a second rigid member that turns vertically downward at a right angle wherein, the second rigid member is welded bonded or molded turns to a third rigid member that turns horizontally at a right angle in line with the first rigid member wherein, an axel or spindle may pass longitudinally and horizontally through the third rigid member and extend beyond the length of the third rigid member to support a wheel and appropriate hardware on one end the spindle and securement hardware on the opposing end of the spindle in order to secure the spindle to the third rigid member.
